(19) United States
(12) Patent Application Publication
(10) Pub. No.: US 2003/0230413 A1
(43) Pub. Date: Dec. 18, 2003

(54) Method for creating a fire-prevention screen and apparatus for its realization

(76) Inventors: Miryalil Khamitovich Usmanov, Tashkent (UZ); Sandjar Giyasovich Umarov, Tashkent (UZ); Nikolai Nikolaevich Broushlinski, Moscow (RU); Evgeny Alexandrovich Serebrennikov, Moscow (RU); Nikolai Petrovich Kopylov, Moscow Region (RU); Abror Giyasovich Umarov, Tashkent (UZ); Abdulla Khamidullaevich Kuldashev, Tashkent (UZ); Nikolai Borisovich Lobanov, Tashkent (UZ); Shamil Sadikov, Tashkent (UZ)

Correspondence Address: ABELMAN, FRAYNE & SCHWAB, 150 East 42nd Street, New York, NY, 10017-5612, US

(21) Appl. No.: 10/414,639

(22) Filed: Apr. 16, 2003

(30) Foreign Application Priority Data
Apr. 19, 2002 (UZ) IDP 2002 0264

(51) Int. Cl. A62C 2/00

(52) U.S. Cl. 169/43

(57) ABSTRACT

The present invention relates to fire-prevention equipment and may be applied for creating various fire-protection screens intended for reflecting and absorbing heat flows of fires.

The essence of the claimed technical solution lies in the fact that in the fire-prevention screen creation method, comprising the steps of setting a metallic net surface and creating a cooling liquid film on this surface, the said cooling liquid film is created by sprinkling of the said cooling liquid by sprinklers on the said net surface in direction which is perpendicular to the said surface or make some angle to that, and so that the said cooling liquid film wholly cover the said net surface.

The essence of the claimed technical solution lies also in the fact that in the fire-prevention screen, comprising a metallic net surface, pipeline and head mounted on this pipeline, it is mounted a lattice frame make from pipes and connected with the said head, and the said frame is parallel aligned to the said net surface at some distance from that, and there are sprinklers mounted on the said frame, and the said sprinklers are located at regular intervals over the whole square of the said net surface.

The proposed method makes possible the creation of a fire-prevention screen, efficiency of which is higher than efficiency of prior art screens. For screen created by the proposed method, the cooling liquid flow rate is 40 times less and the heat flow attenuation is several tens times greater than for the prior art screens.

The present invention relates to fire-prevention equipment and may be applied for creating various fire-protection screens intended for reflecting and absorbing heat flows of fires.

Known in the art is a method of creating a fire-prevention screen by setting a metallic net surface and cooling this surface by water (cf., Roitman M. Ya. Protivopozharnoe normirovanie v stroitel'stve. Moscow, Stroyizdat, 1985). The protective function of such screen performed due to the fact that the net surface cooled by water contains of convective flows of fire and prevents the spread of heat by convective way.

Prior art method, which is closest to that proposed by the present invention, is a method of creating a fire-prevention screen by setting a metallic net surface and creating the film of a cooling liquid on this surface (cf., U.S. RU Pat. No. 2,156,628, 1999). The cooling liquid is supplied from a head mounted in the upper part of the said surface. The cooling liquid (for example, water) is uniformly supplied on the upper part of the said surface and, it flows over one by gravity. Thank to the surface-tension strength, a surface film forms on the net surface at specific size of net cells.

The protective function of the said fire-prevention screen is caused by processes of scattering and absorbing the fire heat flow propagated in form of electromagnetic wave, wavelength of which corresponds to infrared.

Prior art fire-prevention screen, which is closest to that proposed by the present invention, consists of a metallic net surface, pipeline, and head mounted on this pipeline (cf., U.S. RU Pat. No. 2,156,628, 1999). In use, the metallic net surface of the said screen is disposed so that the fire heat flow is perpendicularly directed to this surface. To measure the value of the heat flow, it are used special transducers connected with a measurement result treatment block. One of the transducers is placed ahead of the said screen, and other of ones is placed back of the said screen.

The aforesaid prior art method and screen have disadvantages consisting in their small reliability and also in difficulty to form and use screen when it is great size. This is caused by follows:

1. The water film, which is formed by the head in the upper part of the net surface of screen, is disrupt with distance from the said part of the net surface, and the water run down by the net surface as individual tiny brooks. In case of metallic nets, the water retains the film state for distance of 0.5-1 meter from the upper part of the screen net surface.

2. For the water to be able to run down by the net surface, this surface is to be aligned vertically or close to the vertically position, which set a limit on applications of the said screen.

The present invention eliminates these disadvantages, and it make possible creating a fire-prevention screen, which have more high efficiency and reliability.

The object of the present invention is accomplished owing to the fact that in the fire-prevention screen creation method, comprising the steps of setting a metallic net surface and creating a cooling liquid film on this surface, the said cooling liquid film is created by sprinkling of the said cooling liquid by sprinklers on the said net surface in direction which is perpendicular to this surface or make some angle to that, and so that the said cooling liquid film wholly cover the said net surface.

The object of the present invention is accomplished owing to the fact that in the fire-prevention screen, comprising a metallic net surface, pipeline and head mounted on this pipeline, it is mounted a lattice frame make from pipes and connected with the said head, and the said frame is parallel aligned to the said surface, and there are sprinklers mounted at regular intervals on the said frame. The said frame is disposed at the front of the said net surface on the side of the heat flow incidence, or at the back of the said net surface, or at both sides of the said net surface.

The essence of the claimed technical solution lies in the fact that, by sprinklers arranged at some distance from the said net surface and over the whole square of one, the individual films of the cooling liquid are created on the said net surface, and, in result of its joining, these films form the continuous film of cooling liquid on this net surface, which may be any size and form (from planar to spherical).

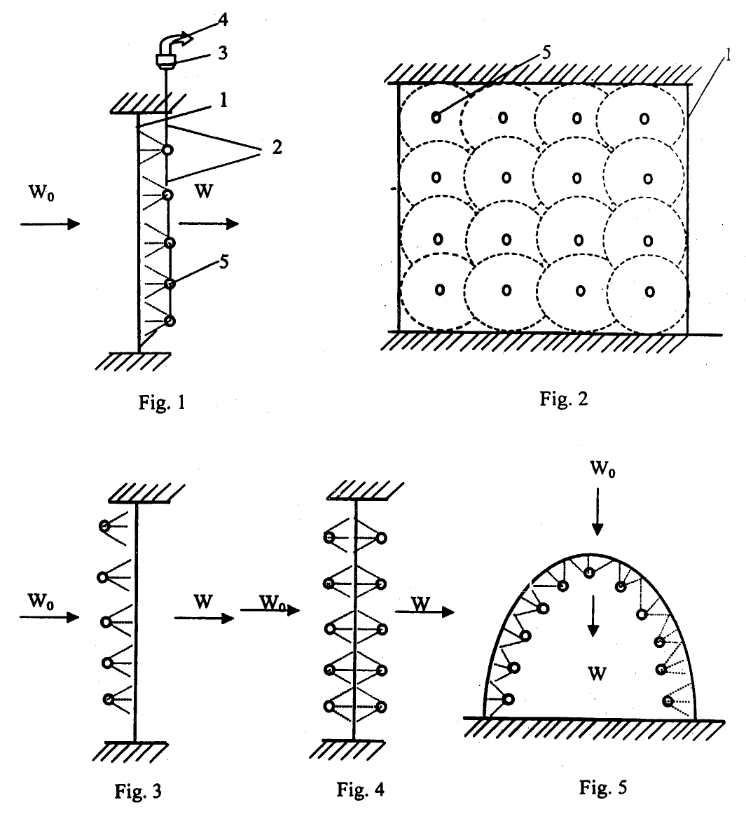

The invention will now be described in detail with reference to the accompanying drawings illustrating a specific embodiment thereof, in which: FIG. 1 is a side view of screen according to the present invention with the cooling liquid supplying on the back side of the planar net surface (W₀—is the density of heat flow incident to screen; W—is the density of heat flow passed through this screen); FIG. 2 is a front view of screen with the cooling liquid supplying on the front side of the planar net surface; FIG. 3 is a side view thereof; FIG. 4 is a side view of screen with the cooling liquid supplying to both side of the planar net surface; FIG. 5 is a side view of screen according to the present invention with the cooling liquid supplying on a curvilinear net surface.

The said screen is comprised of a net surface 1, a frame make from pipes 2 and mounted parallel to the said net surface, a head 3, which connects the said frame with pipeline 4, by means of which the cooling liquid (e.g. water) is supplied. On pipes 2 of frame, there are sprinklers 5, by means of which the cooling liquid is sprinkled on the net surface in direction, which is perpendicular to this surface or make some angle to that. The frame of pipes is disposed on the planar net surface side which is opposite to that on which the heat flow is incident (FIG. 1), or on the planar net surface side on which the heat flow is incident (FIG. 3), or on the both side of the planar net surface (FIG. 4), or on the side of the curvilinear net surface (FIG. 5).

The net surface range sprayed by a cooling liquid with the use of sprinkler is determined by the sprinkler design, by the relative positions of sprinklers, and the distance of sprinklers from the net surface. These parameters are so fitted that there is the continuous film of cooling liquid on the net surface when this cooling liquid is supplied under pressure existing in a cooling-supply system.

At specified values of net size and net wire diameter, there is the continuous film of cooling liquid on the net surface. The size and configuration of the said screen can be anyone. The said screen can be disposed vertically, at an angle to vertical direction, and horizontally. Thank to this, screening objects on all sides using such screens is possible.

The proposed method makes possible the creation of a fire-prevention screen, efficiency of which is higher than efficiency of prior art screens. For screen created by the proposed method, the cooling liquid flow rate is 40 times less and the heat flow attenuation is several tens times greater than for the above mentioned prior art screen in which the cooling liquid film is formed by supplying of cooling liquid from head disposed in the upper part of the screen net surface.

What I claim is:

1. A method for creating a fire-prevention screen, comprising the steps of setting a metallic net surface and creating a cooling liquid film on this surface, characterized in that the said cooling liquid film is created by sprinkling of the said cooling liquid by sprinklers on the said net surface in direction, which is perpendicular to the said surface or make some angle to that, and so that the said cooling liquid film wholly cover the said net surface.

2. A fire-prevention screen, comprising a metallic net surface, pipeline and head mounted on this pipeline, is characterized in that a lattice frame make from pipes and connected with the said head is mounted parallel to the said net surface at some distance from that, and there are sprinklers mounted on the said frame, and the said sprinklers are located at regular intervals over the whole square of the said net surface.

3. A fire-prevention screen according to claim 2, characterized in that the said frame of pipes is disposed at the front of the said net surface on the side of the heat flow incidence, or at the back of the said net surface, or at both sides of the said net surface.
